(19) United States
(12) Patent Application Publication
(10) Pub. No.: US 2011/0196944 A1
(43) Pub. Date: Aug. 11, 2011

(54) SERVICE PROVIDING SYSTEM

(76) Inventor: Hachirou SENO, Fukuoka (JP)

(21) Appl. No.: 13/091,550

(22) Filed: Apr. 21, 2011

Related U.S. Application Data
(63) Continuation of application No. PCT/JP2009/068234, filed on Oct. 23, 2009.

(30) Foreign Application Priority Data
Oct. 29, 2008 (JP) 2008-278110

(51) Int. Cl. G06F 15/16

(52) U.S. Cl. 709/219

(57) ABSTRACT

A service providing system includes a user terminal connected to an electric communication network; a first service provider terminal connected to the electric communication network for providing a first service; and a second service provider terminal connected to the electric communication network for providing a second service. The first service provider terminal generates database containing an identification symbol and personal information for accessing and logging in the first service provider terminal. The first service provider terminal sends the identification symbol to the second service provider terminal when the user terminal accesses to the second service provider terminal while the user terminal logs in the first service provider terminal, so that the second service provider can provide the second service to the user when the second service provider requires the personal information.

### CROSS-REFERENCE TO RELATED APPLICATIONS

This is a continuation application of the prior PCT application PCT/JP2009/068234, filed on Oct. 23, 2009, pending, which claims priority from a Japanese patent application No. 2008-278110, filed on Oct. 29, 2008, the entire content of which is incorporated herein by reference.

### BACKGROUND OF THE INVENTION AND RELATED ART STATEMENT

The present invention relates to a service providing system for providing service through an electric communication network. More specifically, the present invention relates to a service providing system, in which a terminal of a user is connected to a terminal of a first service provider and a terminal of a second service provider through an electric communication network, so that the first service provider and the second service provider are capable of providing a service to the user according to a request of the user.

In recent years, along with the advancement of an electric communication network such as internet, a conventional service providing system has been widely available. In the conventional service providing system, a terminal is connected to the electric communication network for providing a service.

In the conventional service providing system, a user usually registers in advance on a web site of a provider that is providing a service. In the next step, the provider provides the user with an identification symbol and a password specific to the user. Afterward, the user is capable of logging in the web site of the provider using the identification symbol and the password specific to the user. Through the process described above, the user can acquire authentication from the provider, so that the user is capable of receiving the service on the web site of the provider (refer to Patent Reference).

Patent Reference: Japanese Patent Publication No. 2005-202806

In the conventional service providing system described above, when a user is willing to receive services from web sites of a plurality of providers, it is necessary for the user to register or acquire authentication upon logging in on the web site of each of the providers.

As described above, in the conventional service providing system described above, when a user is willing to receive services from web sites of a plurality of providers, it is necessary for the user to register or acquire authentication upon logging in on the web site of each of the providers. Accordingly, the process tends to be cumbersome and inconvenient for the user. Further, when the user accesses to the web site of each of the providers, it is necessary for the user to remember the identification symbol and the password specific to the user for each of the providers.

Further, in the conventional service providing system described above, when a user is willing to receive services from web sites of a plurality of providers, it is necessary for the user to notify the providers of personal information such as a name and a mailing address of the user and a credit card number. Accordingly, there may be a risk of leaking the personal information, thereby causing the user to hesitate to use the conventional service providing system.

In view of the problem described above, an object of the present invention is to provide a service providing system capable of solving the problems of the conventional service providing system.

Further objects and advantages of the invention will be apparent from the following description of the invention.

### SUMMARY OF THE INVENTION

In order to attain the objects described above, according to a first aspect of the present invention, a service providing system includes a user terminal connected to an electric communication network; a first service provider terminal connected to the electric communication network for providing a first service from a first service provider to a user according to a request of the user; and a second service provider terminal connected to the electric communication network for providing a second service from a second service provider to the user according to a request of the user.

According to the first aspect of the present invention, the first service provider terminal is arranged to generate database containing an identification symbol and personal information of the user so that the user terminal is capable of accessing and logging in the first service provider terminal using the identification symbol. The first service provider terminal is arranged to send the identification symbol of the user to the second service provider terminal when the user terminal accesses to the second service provider terminal while the user terminal logs in the first service provider terminal. The second service provider terminal is arranged to allow the user terminal to access to the second service provider terminal when the first service provider terminal sends the identification symbol of the user to the second service provider terminal regardless whether the user registers relative to the second service provider. The second service provider terminal is arranged to receive the personal information of the user obtained from the database with the first provider terminal so that the second service provider can provide the second service to the user using the personal information of the user when the second service provider requires the personal information of the user to provide the second service.

According to a second aspect of the present invention, in the service providing system in the first aspect, the first service provider terminal is arranged to send the personal information of the user to the second service provider terminal according to a request from the second service provider terminal.

According to a third aspect of the present invention, in the service providing system in the first aspect or the second aspect, the first service provider terminal is arranged to send the personal information of the user to the second service provider terminal after the first service provider terminal obtains the personal information of the user from the database and the first service provider provides the first service to the user.

In the present invention, it is possible for the user to receive the second service from the second service provider on a web site of the second service provider without registering or logging in relative to the second service provider once the user registers and logs in relative to the first service provider. Accordingly, it is possible for the user to easily resister and log in, thereby improving convenience of the service providing system using the electric communication network.

Further, in the present invention, it is possible for the user to receive a service without remembering identification symbols and personal information relative to a plurality of service providers.

Further, in the present invention, the user sends the personal information only to the first service provider. Accordingly, it is possible to reduce a risk of leaking the personal information of the user.

Further, in the present invention, the first service provider terminal is arranged to send the personal information of the user to the second service provider terminal according to the request from the second service provider terminal. Further, the first service provider terminal is arranged to send the personal information of the user to the second service provider terminal after the first service provider terminal obtains the personal information of the user from the database and the first service provider provides the first service to the user. Accordingly, it is possible to further efficiently reduce a risk of leaking the personal information of the user.

### BRIEF DESCRIPTION OF THE DRAWINGS

FIG. 1 is a schematic view showing a service providing system according to an embodiment of the present invention;

FIG. 2 is a schematic view showing an operational process of the service providing system according to the embodiment of the present invention; and

FIG. 3 is a schematic view showing a database of the service providing system according to the embodiment of the present invention.

### DETAILED DESCRIPTION OF PREFERRED EMBODIMENTS

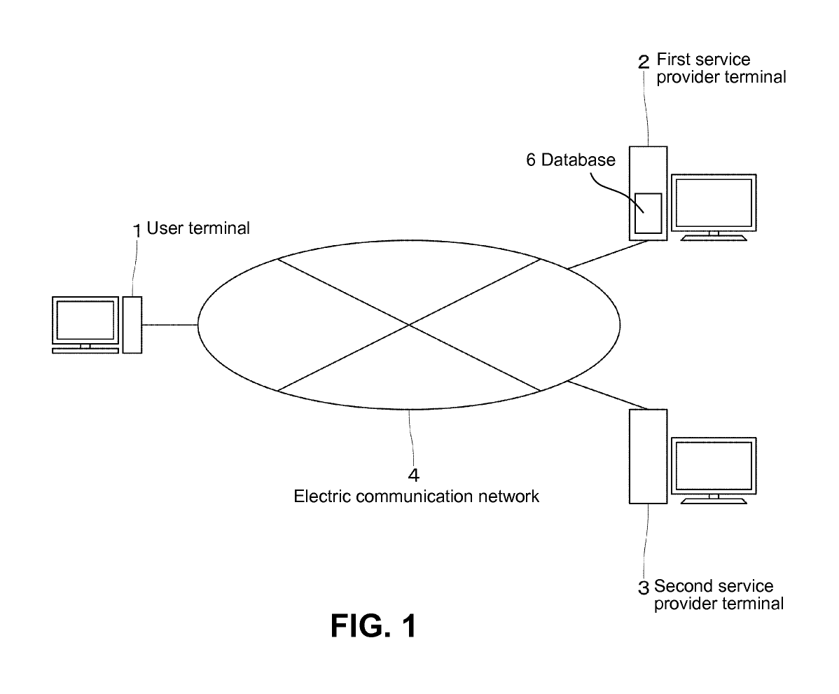

Hereunder, embodiments of the present invention will be explained with reference to the accompanying drawings. FIG. 1 is a schematic view showing a service providing system according to an embodiment of the present invention.

As shown in FIG. 1, in the service providing system, a user terminal 1 of a user is connected to a first service provider terminal 2 of a first service provider and a second service provider terminal 3 of a second service provider through an electric communication network 4. A user is capable of accessing to the first service provider terminal 2 and the second service provider terminal 3 from the user terminal 1 through the electric communication network 4, so that the user can receive services from the first service provider and the second service provider. It is noted that the user terminal 1, the first service provider terminal 2, and the second service provider terminal 3 include various devices with a communication function of electrical data such as a computer, a mobile telephone, a mobile terminal and the likes.

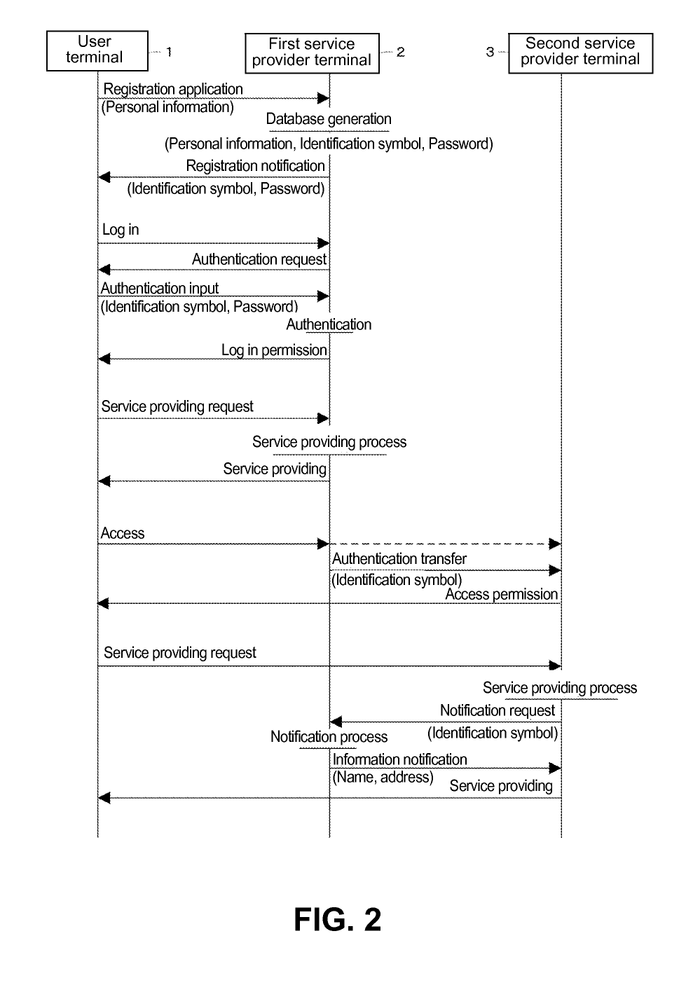

An operational process of the service providing system will be explained next. FIG. 2 is a schematic view showing an operational process of the service providing system according to the embodiment of the present invention.

As shown in FIG. 2, first, the user applies for registration relative to the first service provider (a registration application step). More specifically, the user transmits data of personal information including a name of the user, an address of the user, and a credit card number from the user terminal 1 to the first service provider terminal 2. The data of the personal information may include various other data such as an age of the user, a gender of the user, an email address of the user, a bank account number, and the likes.

In the next step, when the first service provider receives the registration application, the first service provider terminal 2 generates a database 6 including the personal information of the user (a database generation step).

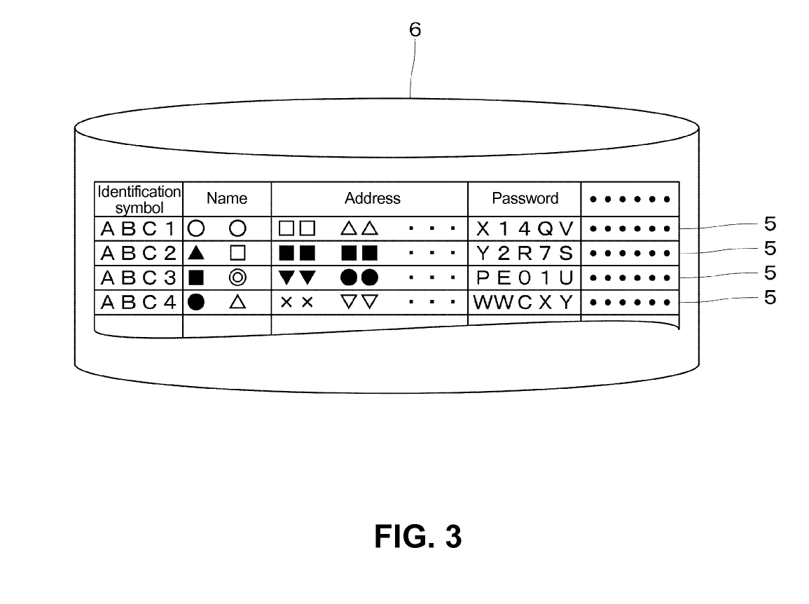

FIG. 3 is a schematic view showing the database 6 of the service providing system according to the embodiment of the present invention. When the first service provider terminal 2 receives the data of the personal information from the user terminal 1, the first service provider terminal 2 adds an identification symbol and/or a password specific to the user to the data of the personal information to generate data 5. Then, the first service provider terminal 2 stores (accumulates) the data 5 in a storage unit thereof to generate the database 6.

In the next step, the first service provider notifies the user that the registration is complete (a registration notification step). More specifically, the first service provider terminal 2 sends a registration completion mail including the identification symbol and/or the password specific to the user to the user terminal 1.

Through the steps described above, it is possible for the user to use web sites of the first service provider and the second service provider using the service providing system according to the embodiment of the present invention.

When the user wants the first service provider or the second service provider to provide the service, the user requests the first service provider to log in (a log in request step). More specifically, the user uses the user terminal 1 to access a web site run by the first service provider through the first service provider terminal 2.

When the first service provider receives the log in request from the user, the first service provider requests the user to authenticate (an authentication request step). More specifically, the first service provider uses the first service provider terminal 2 to request the user to transmit the identification symbol and the password through the user terminal 1.

When the user receives the authentication request, the user inputs the identification symbol and the password for obtaining the authentication from the first service provider (an identification input step). More specifically, the user uses the user terminal 1 to transmit the identification symbol and the password to the first service provider terminal 2 of the first service provider.

When the first service provider receives the identification input, the first service provider authenticates the user using the identification symbol and the password thus input (an authentication step). More specifically, the first service provider terminal 2 of the first service provider compares the identification symbol and the password received from the user terminal 1 of the user with the data 5 of the database 6 generated in the database generation step. Accordingly, the first service provider terminal 2 of the first service provider determines whether the user is a registered user registered in the database 6 in advance.

When the first service provider terminal 2 of the first service provider determines that the user is the registered user, the first service provider issues permission to the user to log in (a log in permission step). More specifically, the first service provider uses the first service provider terminal 2 to transmit a permission notice or display screen data of a top page to the user terminal 1 of the user.

Through the steps described above, it is possible for the user to receive various services on the web site of the first service provider using the service providing system.

When the user wants the first service provider to provide the service on the web site of the first service provider, the user requests the first service provider to provide the service (a service providing request step). More specifically, the user uses the user terminal 1 to select and transmit the service that the user wants to receive through the first service provider terminal 2 of the first service provider.

When the first service provider receives the service providing request from the user, the first service provider performs various processes according to the contents of the service (a service providing process step). More specifically, the first service provider terminal 2 of the first service provider retrieves the personal information of the user from the data 5 of the database 6 according to necessity to perform a necessary process (for example, issuing or reserving a ticket).

In the next step, the first service provider provides the service to the user (a service providing step). More specifically, the first service provider uses the first service provider terminal 2 to notify a process result in the service providing process step to the user terminal 1 of the user.

When the user wants the second service provider to provide the service on the web site of the second service provider, the user accesses to the web site of the second service provider through the web site of the first service provider while the user still logs in the web site of the first service provider (an access step). More specifically, the user uses the user terminal 1 to select the service of the second service provider linked to the web site of the first service provider through the first service provider terminal 2 of the first service provider, so that the user terminal 1 of the user accesses to the second service provider terminal 3 of the second service provider.

At this moment, the first service provider notifies the second service provider that the first service provider already authenticates the user (an authentication transfer step). More specifically, the first service provider terminal 2 of the first service provider transmits the identification symbol of the user to the second service provider terminal 3 of the second service provider.

In the next step, when the first service provider transfers the authentication of the user to the second service provider, the second service provider issues the permission to access to the web site of the second service provider regardless of whether the user registers on the web site of the second service provider. More specifically, the first service provider uses the first service provider terminal 2 to transmit a permission notice or display screen data of a top page to the user terminal 1 of the user.

Through the steps described above, it is possible for the user to receive various services on the web site of the second service provider using the service providing system.

When the user wants the second service provider to provide the service on the web site of the second service provider, the user requests the second service provider to provide the service (a service providing request step). More specifically, the user uses the user terminal 1 to select and transmit the service that the user wants to receive through the second service provider terminal 3 of the second service provider.

When the second service provider receives the service providing request from the user, the second service provider performs various processes according to the contents of the service (a service providing process step). More specifically, the second service provider terminal 3 of the second service provider performs a necessary process (for example, issuing or reserving a ticket).

At this moment, when the second service provider needs the personal information of the user, the second service provider request the first service provider to transmit the personal information of the user (a notification request step). More specifically, the second service provider terminal 3 of the second service provider requests the first service provider terminal 2 of the first service provider to transmit the identification symbol of the user or a type of necessary personal information of the user (for example, a name, an address, and the like).

When the first service provider receives the notification request, the first service provider performs a process to obtain the personal information necessary for the notification (a notification process step). More specifically, the first service provider terminal 2 of the first service provider compares the identification symbol received from the second service provider terminal 3 of the second service provider with the data 5 of the database 6 generated in the database generation step. Accordingly, the first service provider terminal 2 of the first service provider retrieves the personal information of the user corresponding to the type of necessary personal information transmitted from the second service provider terminal 3 of the second service provider from the data 5 of the database 6.

At this moment, it is configured such that the first service provider terminal 2 of the first service provider does not notify the personal information to the second service provider terminal 3 of the second service provider until the first service provider terminal 2 of the first service provider retrieves the personal information of the user from the data 5 of the database 6 and the first service provider provides the service to the user.

Afterward, the first service provider notifies the personal information thus requested to the second service provider (an information notification step). More specifically, the first service provider terminal 2 of the first service provider transmits the personal information of the user retrieved in the notification process step along with the identification symbol to the second service provider terminal 3 of the second service provider.

Afterward, the second service provider provides the service to the user (a service providing step). More specifically, the second service provider uses the second service provider terminal 3 to notify a process result in the service providing process step to the user terminal 1 of the user. At this moment, if necessary, the second service provider terminal 3 of the second service provider performs a necessary process (for example, a process of reserving or issuing a ticket) using the personal information of the user obtained from the first service provider terminal 2 of the first service provider.

As described above, in the service providing system of the present invention, the user terminal 1 of the user is connected to the first provider terminal 2 of the first service provider and the second provider terminal 3 of the second service provider through the electric communication network 4, so that the first service provider and the second service provider can provide the services to the user according to the request of the user.

In the service providing system of the present invention, the first service provider terminal 2 of the first service provider generates the database 6 containing the identification symbol and the personal information of the user. Then, the user terminal 1 of the user logs in the first service provider terminal 2 of the first service provider using the identification symbol of the user. When the user terminal 1 of the user access to the second service provider terminal 3 of the second service provider while the user terminal 1 of the user logs in the first service provider terminal 2 of the first service provider, the first service provider terminal 2 of the first service provider notifies the identification symbol of the user to the second service provider terminal 3 of the second service provider. When the second service provider terminal 3 receives the identification symbol of the user from the first service provider terminal 2 of the first service provider, the second provider terminal 3 is arranged to allow the user terminal 1 to access to the second provider terminal 3 when the first provider terminal 2 sends the identification symbol of the user to the second provider terminal 3 regardless whether the user registers relative to the second service provider.

When the second service provider requires the personal information of the user to provide the service, the second provider terminal 3 is arranged to receive the personal information of the user obtained from the database 6 with the first provider terminal 2, so that the second service provider 3 can provide the service to the user using the personal information of the user.

Accordingly, it is possible for the user to receive the service from the second service provider on the web site of the second service provider without registering or logging in relative to the second service provider once the user registers and logs in on the web site of the first service provider. As a result, it is possible for the user to easily resister and log in, thereby improving convenience of the service providing system using the electric communication network 4.

Further, it is possible for the user to receive the service without remembering the identification symbols and the personal information relative to a plurality of service providers. In the service providing system of the invention, the user sends the personal information only to the first service provider. Accordingly, it is possible to reduce a risk of leaking the personal information of the user.

In the service providing system of the invention, when the user terminal 1 of the user access to the second service provider terminal 3 of the second service provider while the user terminal 1 of the user logs in the first service provider terminal 2 of the first service provider, the first service provider terminal 2 of the first service provider notifies the identification symbol of the user to the second service provider terminal 3 of the second service provider, thereby imparting a function called a single sign-on.

In the service providing system of the invention, in addition to the single sign-on function, the second service provider receives the personal information of the user from the first service provider regardless whether the user registers to the second service provider. Accordingly, once the user registers the personal information to the first service provider, it is not necessary for the user to register the personal information to the second service provider.

In the service providing system of the invention, when the user registers to both the first service provider and the second service provider, the personal information registered in the first service provider becomes priority to be used. Accordingly, when the personal information of the user, for example, an address or a bank account, is changed, it is not necessary for the user to update the personal information registered in the second service provider.

In the service providing system of the invention, it is possible for the user to conveniently select information such as different bank accounts, thereby improving convenience of the service providing system. For example, it is supposed that the user registers the bank account A in the first service provider and the bank account B in the second service provider. When the user uses the service of the second service provider through the first service provider, the user can make a payment from the bank account A registered in the first service provider. When the user uses the service of the second service provider directly, the user can make a payment from the bank account B registered in the second service provider, thereby making it possible for the user to select the bank accounts.

In the service providing system of the invention, it is configured such that the first service provider transfers the personal information of the user to the second service provider according to the request from the second service provider. Accordingly, it is possible to further reduce the risk of leaking the personal information.

In the service providing system of the invention, it is configured such that the first service provider transfers the personal information of the user to the second service provider after the first service provider retrieves the personal information of the user from the database 6 and provides the service to the user. Accordingly, it is possible to further reduce the risk of leaking the personal information.

The disclosure of Japanese Patent Application No. 2008-278110, filed on Oct. 29, 2008, is incorporated in the application.

While the invention has been explained with reference to the specific embodiments of the invention, the explanation is illustrative and the invention is limited only by the appended claims.

What is claimed is:

1. An service providing system, comprising:
a user terminal connected to an electric communication network;
a first service provider terminal connected to the electric communication network for providing a first service from a first service provider to a user according to a request of the user; and
a second service provider terminal connected to the electric communication network for providing a second service from a second service provider to the user according to a request of the user,
wherein said first service provider terminal is arranged to generate database containing an identification symbol and personal information of the user so that the user terminal is capable of accessing and logging in the first service provider terminal using the identification symbol,
said first service provider terminal is arranged to send the identification symbol of the user to the second service provider terminal when the user terminal accesses to the second service provider terminal while the user terminal logs in the first service provider terminal,
said second service provider terminal is arranged to allow the user terminal to access to the second service provider terminal when the first service provider terminal sends the identification symbol of the user to the second service provider terminal regardless whether the user registers relative to the second service provider, and
said second service provider terminal is arranged to receive the personal information of the user obtained from the database with the first provider terminal so that the second service provider can provide the second service to the user using the personal information of the user when the second service provider requires the personal information of the user to provide the second service.

2. The service providing system according to claim 1, wherein said first service provider terminal is arranged to send the personal information of the user to the second service provider terminal according to a request from the second service provider terminal.

3. The service providing system according to claim 1, wherein said first service provider terminal is arranged to send the personal information of the user to the second service provider terminal after the first service provider terminal obtains the personal information of the user from the database and the first service provider provides the first service to the user.
